(19) United States
(12) Patent Application Publication
(10) Pub. No.: US 2009/0213081 A1
(43) Pub. Date: Aug. 27, 2009

(54) Portable Electronic Device Touchpad Input Controller

(76) Inventor: Charlie W. Case, JR., Lake Oswego, OR (US)

Correspondence Address: IPSOLON LLP, 111 SW COLUMBIA, SUITE 710, PORTLAND, OR, 97201, US

(21) Appl. No.: 11/971,836

(22) Filed: Jan. 9, 2008

Related U.S. Application Data
(60) Provisional application No. 60/879,990, filed on Jan. 10, 2007.
(60) Provisional application No. 60/968,029, filed on Aug. 24, 2007.

(51) Int. Cl. G06F 3/041

(52) U.S. Cl. 345/173

(57) ABSTRACT

A touchpad input controller receives user input relating to a display. The input controller includes a facing surface that faces a user when the controller is held in the user's hand or hands during use, and one or more non-facing surfaces that each faces away from the user when the controller is held the user's hand or hands during use. At least one non-facing surface includes a touchpad input area that is positioned to be accessed by at least one user finger for receiving user input. The facing surface including a display on which the results of user input received at the touchpad input area is displayed. The touchpad input area includes a mapping to a virtual keyboard layout for receiving keyboard-equivalent input from the user at the touchpad input area.

### RELATED APPLICATION

The present application claims the benefit of the filing of provisional application No. 60/879,990 filed Jan. 10, 2007 and provisional application No. 60/968,029, filed Aug. 24, 2008.

### BACKGROUND AND SUMMARY OF THE INVENTION

Many electronic products available today employ input and output devices such as displays, keyboards, mice, joysticks, inertial devices, wireless inertial pointers, jog wheels, touchpads, touch sensitive displays, and so forth to exchange information with humans. For many such products, particularly portable devices employing keyboards, keypads, or phone dialpads (generally referred to collectively herein as keyboards), it is becoming more and more challenging to provide a keyboard of sufficient size to provide an effective method of inputting keystrokes or other button or key selections. An effective portable mouse interface is also a challenge. Examples of such products include personal digital assistants, such as Blackberry™ PDAs, cell phones, gps devices, music players such as MP3 players, watches, personal digital assistants, and so forth. In the specific case of a Blackberry™ PDA, for example, the product may employ a “qwerty” style keyboard with nearly 60 keys or buttons. It is less than ideal to have so many keys located so close together, and represents a problem to consumers of such products.

In addition to having “usability” problems, some of the human input devices such as keyboards may have manufacturing or reliability problems. It is difficult to manufacture a device with a large number of buttons or keys due to large number of pieces. There may be reliability problems with moving buttons and it is also expensive to manufacture such devices. In the field, many may have reliability problems occur with so many moving parts and their susceptibility to dirt, dust, water, etc.

These types of devices allow a user to select graphical icons, numbers, letters, or make other such selections or decisions to interact with and operate a device. Cell phones use numeric or alphabetic keypads. Computers typically have keyboards. Remote control devices for television or multimedia or audio or video players centers also have large numbers of buttons or keys. Eliminating some or all of these buttons would be desirable on such devices.

There have been some attempts to provide user input or interaction without a keyboard with numerous buttons or keys. For example, some GPS devices available from Garmin employ a jog wheel that allows a user to rotate the wheel and scroll through letter or number selections, and then depress the wheel to make a selection. While adequate for making selections from short lists, this type of input is very slow very for inputting text. There are also touch-sensitive display screens for key or icon selection, but use of these blocks a user's view of the display and are also slow for inputting text.

The present invention provides a touchpad input controller for receiving user input relating to a display. In one implementation, the input controller includes a facing surface that faces a user when the controller is held in the user's hand or hands during use, and one or more non-facing surfaces that each faces away from the user when the controller is held the user's hand or hands during use. At least one non-facing surface includes a touchpad input area that is positioned to be accessed by at least one user finger for receiving user input. The facing surface including a display on which the results of user input received at the touchpad input area is displayed. The touchpad input area includes a mapping to a virtual keyboard layout for receiving keyboard-equivalent input from the user at the touchpad input area.

Being positioned on a non-facing surface, user access to the touchpad input area does not block the user's view of the display. Moreover, the touchpad area is a generally solid-state structure that does not require the large numbers of separate pieces employed in conventional keypads or keyboards.

The present invention separates the touch sensitive pad from the display. An advantage is that the fingers do not block the display as you make selections, which occurs with conventional “touch screens.” Additionally, it may be more comfortable and natural to place the fingers on the side or back of the product as it is held during use. One embodiment employs a touchpad capable of simultaneously detecting and tracking multiple fingertip contact points, gestures, and finger pressures such as, for example, a capacitive touchpad enabled with multi-touch sensing.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1A is an elevation view of a user operating an input device as an operating environment of a touchpad input controller of the present invention.

FIG. 1B is a bottom plan view of the user holding the input device.

FIG. 2 is an illustration of front, side, and back views of an input device with a display on a facing surface that faces a user when the device is in use.

FIG. 3 is an illustration of front, side, and back views of an input device with an active display and a separate keyboard display.

FIG. 4 is an illustration of front, side, and back views of an input device with a keyboard display and local communication channel to a separate display.

FIG. 5 is an illustration of an input device, such as a game controller, that includes no display.

FIG. 6 is an illustration of front, right side, and left side views of an input device with right and left touchpad input areas.

FIGS. 7A, 7B, and 7C are diagrams illustrating an input device with a hinged coupling between a display and a touchpad input area.

FIGS. 8A, 8B, and 8C are diagrams illustrating a input device with hinged couplings between a display and right and left touchpad input areas.

FIG. 9 is an illustration of a laptop computer employing a touchpad input controller.

### DETAILED DESCRIPTION OF PREFERRED EMBODIMENTS

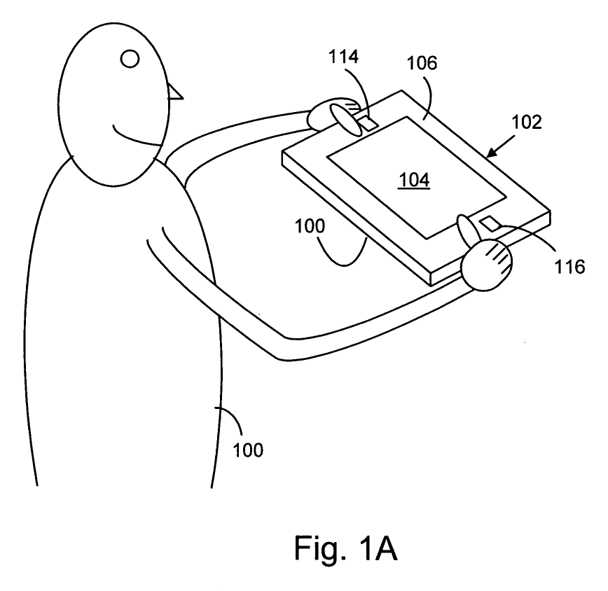

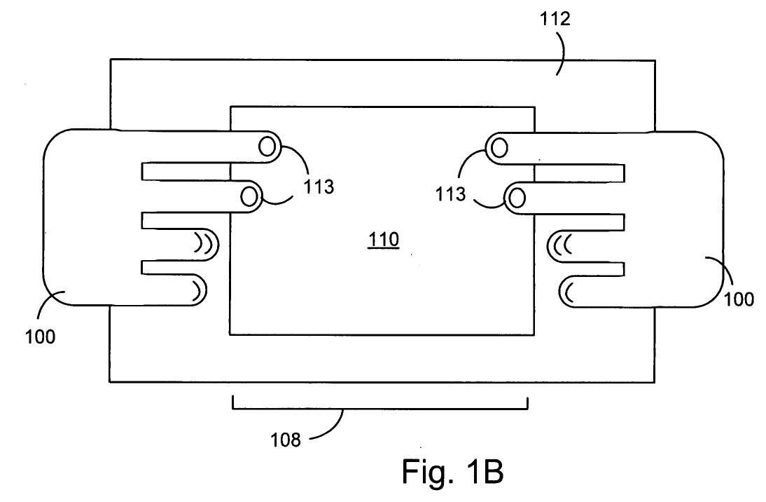

FIG. 1A is an elevation view of a user 100 operating an input device 102 with a display 104 on a facing surface 106 (e.g., top or front) that faces user 100 as an operating environment of a touchpad input controller 108 (FIG. 1B) of the present invention. FIG. 1B is a bottom plan view of user 100 holding input device 102. Controller 108 includes at least one touchpad 110 on a non-facing surface 112 (e.g., a bottom or rear surface, or a side surface or surfaces) that faces away from user 100 when controller 108 is held in the user's hand or hands during use. One or more fingers 113 of one or both hands are used on the at least one touchpad 110 to enter user input into controller 108. In the case of more than one fingertip controlling input, controller 108 may simultaneously track the movement of multiple fingertips touching touchpad 110 (“multi-touch”). In this embodiment, controller 108 includes optional left and right control buttons or keys 114 and 116 that are positioned to be accessed and operated by the user's thumbs as, for example, input mouse select buttons, keyboard control keys (e.g. space, return, etc.), or as any other type of control or other function.

As a smaller device 102, controller 108 may include on non-facing surface 112 only one touchpad 110 on which one or more fingers of one or both hands are used. As a larger device 102, like a laptop or tablet computer, controller 108 may include on non-facing surface 112 separate right and left side touchpads 110 (not shown), the fingers of the user's respective right and left hands. The touchpad or touchpads 110 of controller 108 may be used to provide free cursor motion in a manner analogous to conventional touchpad or mouse inputs or to provide keyboard-equivalent input from the user, or may be switched by the user between free cursor motion or keyboard equivalent input. As used herein, “free cursor motion” is meant to describe a graphical cursor or cursors within a graphical user interface. In the specific example of a personal computer running Microsoft Windows operating system, for example, this cursor would traditionally be controlled by the mouse or trackball. The cursor would be navigated under user control to select icons, highlight text for cutting and pasting, switch contexts, browse the internet, select hyperlinks, select or move icons, and so forth. In one embodiment, the cursor or cursors may actually be a representation of one or more fingertips as they move along the touchpad. For example, the cursor or cursors may appear as spots that get larger or darker with increased finger contact pressure. With a multi-touch implementation, for example, a user could highlight (e.g., make larger or darker) one of the multiple cursors by increasing the pressure of the corresponding finger against the touchpad.

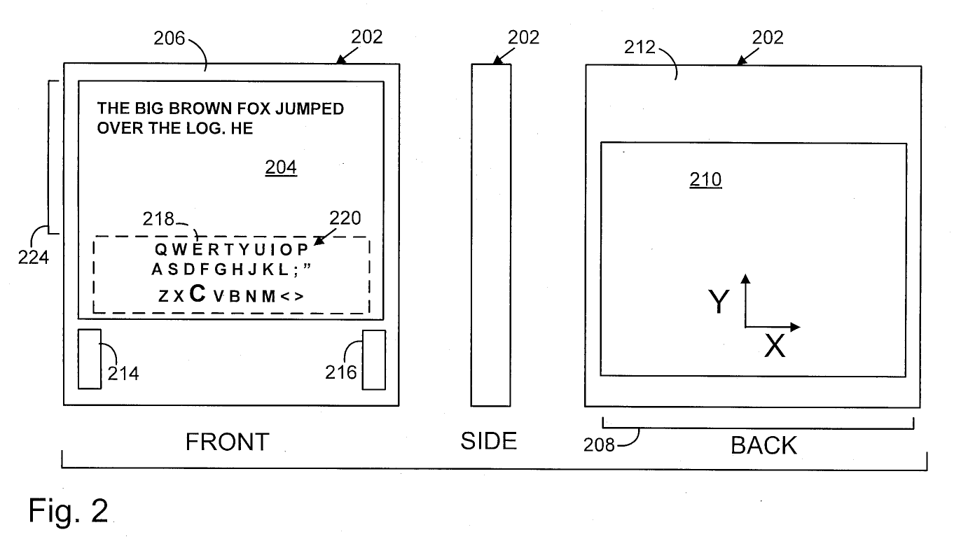

FIG. 2 is an illustration of front, side, and back views of an input device 202 with a display 204 on a facing surface 206 (e.g., top or front) that faces a user when the device is held in the user's hand or hands for use. A touchpad input controller 208 includes a touchpad 210 on a non-facing surface 212 (e.g., a bottom or rear surface, or a side surface or surfaces) that faces away from the user when device 202 is held in the user's hand or hands during use. One or more fingers of both the hands are used on touchpad 210 to enter user input into controller 208. Controller 208 includes optional left and right control buttons or keys 214 and 216 that are positioned on facing surface 206 to be accessed and operated by the user's thumbs as, for example, right or left mouse select buttons, keyboard control keys (e.g. space, return, backspace, etc.), or as any other type of control or other function. The user may assign any such functionality to keys 214 and 216 or may use a predefined default functionality for each.

Controller 208 illustrates operation in a keyboard-equivalent input mode for text entry, in what may be a text document, web page, email, blog, etc. Display 204 includes a keyboard display area 218 that displays the letters of a virtual keyboard 220. Keyboard display area 218 shows a standard QWERTY-style arrangement. It will be appreciated, however, that any keyboard arrangement could be displayed in keyboard display area 218. In addition, virtual keyboard 220 could alternatively include any number of virtual control keys (not shown) that have assigned control key functions that are the same as, or different from those assigned to control keys 214 and 216.

Touchpad 210 on non-facing surface 212 allows the user to make key selections using one or more fingertips on one or both hands. Locations on touchpad 210 may be mapped directly to a keyboard layout that corresponds to virtual keyboard 220. Alternatively, the motion of fingers in contact with touchpad 210 may change the key selections through gestures and relative movement, as with a mouse. As the user moves his hands or fingers over touchpad 210, visual feedback is provided on virtual keyboard 220 that is displayed in keyboard display area 218 to indicate which letter or letters are currently selected. The left and right forefingers may simultaneously highlight two letters for faster typing.

There are many ways to provide visual feedback that indicates which key or keys are currently being selected. A selected letter or key may change a visible physical attribute, such as size, color, font style (e.g., bold vs not bold), etc. As illustrated in FIG. 2, for example, the letter “C” in virtual keyboard 220 is enlarged relative to the other letters, as though coming under the view of a magnifying glass, to indicate that it is currently selected. This graphical technique is used on Mac computer products (OSX) of Apple Computer Company when the mouse cursor is moved along the “toolbar” at the bottom of the screen. In addition, controller 208 may provide other sensory feedback, whether audible or tactile, to indicate selection or selection changes. One aspect of enlarging the selected key or letter is that the remaining keys or letters could be displayed in a smaller size, and thereby reducing the size of virtual keyboard 220 and keyboard display area 218.

The user may then enter the selected text key in a number of different ways, such as pressing a corresponding one of control keys 214 and 216 (or similar control keys positioned on non-facing surface 212), touching touchpad 210 at the selected location with a second touch or tap, or touching touchpad 220 with a uniquely identifiable strokes, gestures, touch, pressure, duration, etc. To enable selection by finger pressure, the X-Y keypad may need to detect force (z-direction, into the plane of the touchpad) using one of a variety of methods including resistance change, capacitance change, image change, etc., as are known in the art. The selected text entry may be user-definable from among any or all of these options. In some embodiments, audible or tactile feedback is provided to the user to indicate when a selection is entered. As with conventional keyboards, such distinct tactile and audible feedback when a key has been depressed can greatly increase typing speed. The entered text is displayed in an active display area 224. In the illustrated example, active display area 224 displays the currently entered text fragment as “THE BIG BROWN FOX JUMPED OVER THE LOG. HE”

Touchpad 210 may have a separate selection area for each hand. As with a traditional keyboard, one or more fingers of the left hand are used to select virtual keys on the left side of the virtual keyboard 220, and one or more fingers of the right hand are used to select virtual keys on the right side. Touchpad 210 would therefore be actively controlling two simultaneous selection areas: one for each hand. Alternatively, two separate touchpads (not shown) could be substituted for the right and left portions of touchpad 210.

It will be appreciated that the mapping of locations on touchpad 210 to a keyboard difference from the conventional free-motion cursor operation of a traditional touchpad. The text entry or keyboard operating mode of touchpad 210 in controller 208 employs a stepped or mapped motion between discrete keys in virtual keyboard 220 as finger positions are changed, rather than a free moving cursor type of control.

Touchpad 210 detects motion in two dimensions, sometimes referred to as X- and Y-directions. The mapping or scaling of the X-Y finger movement on touchpad 210 that corresponds to key selection areas on virtual keyboard 220 is adjustable by the user. For example, the user may set the scaling so that it takes several swipes of the right finger to move across the keypad being displayed. This may allow virtual keyboard 220 to be made very small, whereas touchpad 210 is more in scale with the human hand. In a product such as a Blackberry™ personal digital assistant, for example, the physical keyboard on the front has a lower limit for how small it can be made, due to the size of the typical human hand and the required separate mechanical key for each letter. Controller 208 of the present invention would allow the displayed virtual keyboard 220 to be very small, thereby allowing the overall device to be reduced in size. Alternatively, only a portion of the keys may be shown at any one time, with more keys coming into view with X-Y text entry movement on touchpad 210. Additionally, controller 208 of the present invention may allow all or part of a conventional keyboard to be removed, thereby allowing the forward facing display to be correspondingly. For example, controller 208 may be used primarily for text entry applications while a standard numeric keypad is used for numeric entry applications, or vice versa.

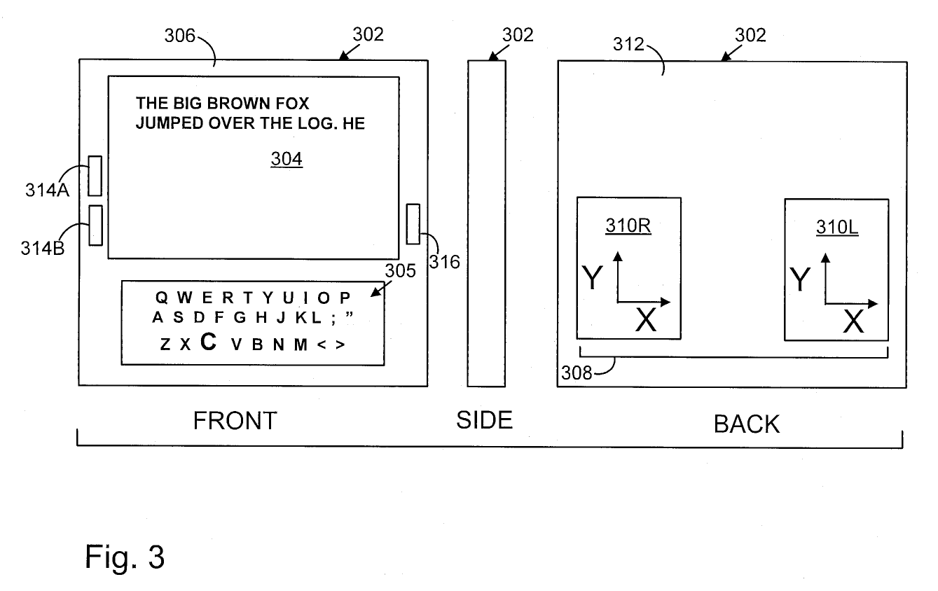

FIG. 3 is an illustration of front, side, and back views of an input device 302 with an active display 304 and a separate keyboard display 305 on a facing surface 306 (e.g., top or front) that faces a user when the device is held in the user's hand or hands for use. A touchpad input controller 308 includes right and left touchpads 310R and 310L on a non-facing surface 312 (e.g., a bottom or rear surface, or a side surface or surfaces) that faces away from the user when device 302 is held in the user's hand or hands during use. One or more fingers of the user's right and left hands are used on respective touchpads 310R and 310L to enter user input into controller 308.

Controller 308 includes more than one (e.g., two) left control buttons or keys 314A and 314B and one right control button or key 316 that are positioned on facing surface 306 to be accessed and operated by the user's thumbs. In one implementation, left control keys 314A and 314B are designated as a “shift” key and a left mouse key, respectively, and right control key 316 may be designated a right mouse key. It will be appreciated, however, that control keys 314A, 314B, and 316 may be used as other input mouse select buttons, keyboard control keys (e.g. space, return, etc.), or as any other type of control or other function. It will be appreciated that active display 304 and separate keyboard display 305 could alternatively be employed with a single touchpad, such as touchpad 210 of controller 208.

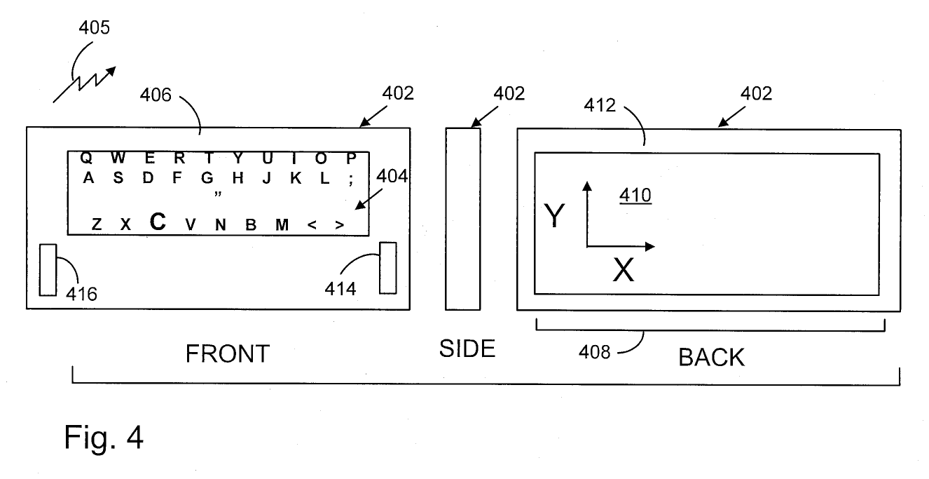

FIG. 4 is an illustration of front, side, and back views of an input device 402 with a keyboard display 404 and local communication channel 405 (e.g., wireless) to a separate display, such as a television or a display monitor (not shown). Keyboard display 404 is positioned on a facing surface 406 (e.g., top or front) that faces a user when the device 402 is held in the user's hand or hands for use. A touchpad input controller 408 includes a touchpad 410 on a non-facing surface 412 (e.g., a bottom or rear surface as shown, or a side surface or surfaces) that faces away from the user when device 402 is held in the user's hand or hands during use. One or more fingers of one or both of the user's hands are used on touchpad 410 to enter user input into controller 408.

Controller 408 includes a right control button or key 414 and a left control button or key 416 that are positioned on facing surface 406 to be accessed and operated by the user's thumbs. In one implementation, one of control keys 414 and 416 may be designated as a text key selection control and the other may be designated to switch controller 408 from a text entry mode to a free cursor mode. It will be appreciated, however, that control keys 414 and 416 may operate as, for example, input mouse select buttons, keyboard control keys (e.g. space, return, etc.), or as any other type of control or other function. In this implementation, device 402 and controller 408 function to control text and inputs that are displayed on the separate display device. As a result, device 402 and controller 408 can function as an input device or remote control for the separate display device or other equipment also in communication with the display device.

In another alternative implementation, such as operation as a remote control for a television, computer, or media center, keyboard display 404 could be omitted from device 402 and substituted with a virtual keyboard display on the television or media center, as described above with reference to keyboard display area 220 of device 202. Movements of the user's finger or fingers on touchpad 410, or key selections, are communicated (e.g., wirelessly) to a display controller associated with the television so that key selections may be displayed on the television.

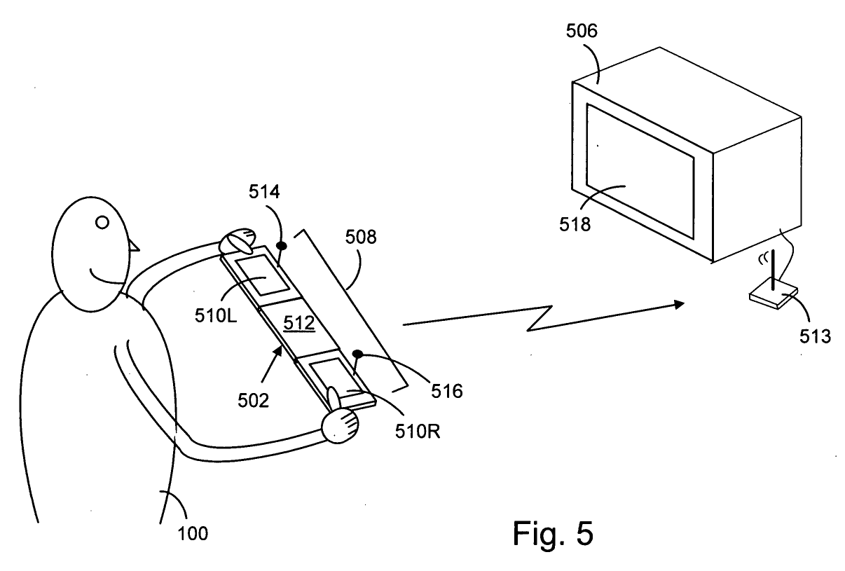

FIG. 5 is an illustration of an input device 502, such as a game controller, that includes no display, but rather includes a local communication channel 505 (e.g., wireless or wired) to a separate display, such as a television 506 or other display monitor. A touchpad input controller 508 includes left and right touchpads 510L and 510R on a facing surface 512 (e.g., a top or front surface as shown) that faces the user when device 502 is held in the user's hand or hands during use. One or more fingers of one or both of the user's hands, or the user's thumbs, are used on touchpads 510L and 510R to enter user input into controller 508, which is transmitted over communication channel 505 to a receiver 513 coupled to television 506.

Controller 508 includes a left joy stick 514 and a right joy stick 516 that are positioned on facing surface 506 to be accessed and operated by the user's thumbs, optionally with one or more control keys or buttons (not shown). In this implementation, device 502 and controller 508 function to enter and control text and game play inputs that are displayed on television 506. As a result, device 502 and controller 508 can function as an input device, with keyboard entry mode and free motion cursor mode, and as a remote control game controller with the modes and controls characteristic of such devices for use with video games such as PS2,Xbox, computer-based video games, and the like. For example, in free cursor mode within a game, the touchpad or touchpads may control player movement, weapon selection, point of view, etc., as in known in the art. In a key entry mode, television 506 may render includes a keyboard display area 518 that displays the letters of a virtual keyboard.

Game controller 502 may be used in several positions, such that the axis orientation may need to be changed as previously discussed, one may employ an accelerometer, level switch, or other such means to properly identify which orientation the device is in and select the proper direction of control or control mode. For example, in one orientation the touchpad or touchpads could control point of view, and in another orientation the touchpad or touchpads could control movement direction.

As described above, input controls of the present invention may be operated in a keyed entry mode or a free motion cursor mode. The user may select between the keyed entry mode and the free motion cursor mode in several ways. For example, the user may switch from the keyed entry mode to the free motion cursor mode by activating a control key or touch-screen control or virtual control key in the virtual keyboard or by indicating motion on the touchpad to a region beyond that mapped to the keyboard operating mode or that mapped to the free motion cursor operating mode. In this implementation, the controller operating mode (i.e., keyboard or free motion cursor) would depend on where the cursor is located on the display, namely, in the continuous cursor general display area or in the step-wise cursor keyboard display area. The user could switch between modes by moving to the edge of the current operating mode and then sweeping or swiping a finger in the direction of the display area corresponding to the other operating mode.

As another example, virtual control keys, or a “toolbar” of icon controls may be accessed or brought up by the user moving the cursor against a selected display edge. The virtual control keys or “toolbar” of icon controls may allow the user to select the keypad, or number pad, or cause the device to switch contexts or modes of operation, etc.

The implementations described above refer to alphabetic keyboard inputs that are characteristic of devices that are equipped with alphabetic keyboards, such as laptop and tablet computers and personal digital assistant device such as a Blackberry™ PDA. It will be appreciated, however, the input controller of the present invention could be used with any handheld device that employs input keys or keyboards, including alphabetic keys or keyboards, numeric keys or keyboards, or specific sets of control keys.

For example, the input controller of the present invention could replace the numeric keypad and floating cursor control on a cellular telephone, the various control keys on a television or video player remote control, or the jog wheel and other inputs on a GPS product to allow destination text input selection, or the various keys or control inputs for a watch, an integrated handheld/portable game device (e.g., Gameboy™, PSP, etc.), a calculator, a health care device, a portable industrial computer module (e.g., shipper delivery computers used by express carriers such as United Parcel Service and FedEx), direct radio communicators (e.g. “walkie-talkies”), ultra-mobile personal computers, personal heads-up displays (e.g., eyeglass heads-up display with a watch touchpad controller), portable electronics device with user input and output, game controllers used with personal computers or game consoles and televisions, etc. having separate or remote displays.

The implementations described above refer to two-dimensional touchpads that detect motion in two dimensions, sometimes referred to as X- and Y-directions. It will be appreciated, however, that in some implementations, typically those having significantly fewer than a full alphabetic set of keys, one or two one-dimensional touchpads or slider controls could alternatively be used. Such one-dimensional touchpads could better accommodate the smaller sizes of some devices while providing sufficient user input control. Such one-dimensional touchpads could be linear, along the back or non-facing sides of a device, or could be curved or circular on a facing or non-facing surface. In the case of a watch, for example, there may be graphical icons displayed on the watch face, and the circular bezel of the watch may be touch sensitive along its length as a one-dimensional touchpad. In the case of a cellular telephone, a one-dimensional pad could allow scrolling through lists, or other such tasks on the primary or secondary phone display For example, some cell phone and some laptops have a secondary display that is on the outside of the lid of the device and is visible when the lid is closed.

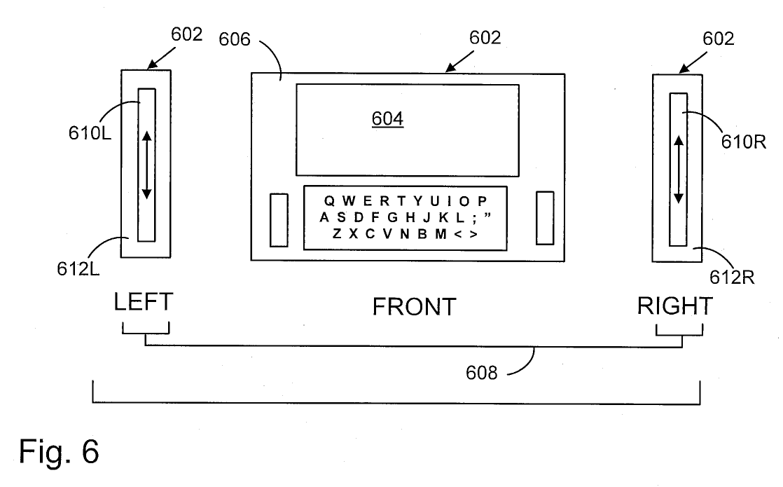

FIG. 6 is an illustration of front, right side, and left side views of an input device 602 with a display 604 on a facing surface 606 (e.g., top or front) that faces a user when the device is held in the user's hand or hands for use. A touchpad input controller 608 includes right and left touchpads 610R and 610L on non-facing right and left side surfaces 612R and 612L that face away from the user when device 602 is held in the user's hand or hands during use. One or more fingers of the user's right and left hands are used on respective touchpads 610R and 610L to enter user input into controller 608. Controller 608 may include one or more control buttons or keys (not shown) on the right and left sides of facing surface 606 to be accessed and operated by the user's thumbs, as described above.

In one implementation, touchpads 610R and 610L may be two-dimensional touchpads and operate in substantially the same manner as touchpads 310R and 310L of device 302 (FIG. 3). Touchpads 610R and 610L may be positioned on respective non-facing side surfaces 612R and 612L to facilitate user reach to them if device 602 has a relatively large thickness that could make it difficult to reach around to a back or rear surface that is opposite facing surface 606.

In an alternative implementation, touchpads 610R and 610L may be one-dimensional linear touchpads that separately control X- and Y-direction motion (or row and column selection). One-dimensional touchpads 610R and 610L may be positioned on respective non-facing side surfaces 612R and 612L to facilitate user access to them if device 602 is relatively small. This implementation may be a desirable configuration for certain device types such as game controllers, GPS devices, cellular telephones, and the like.

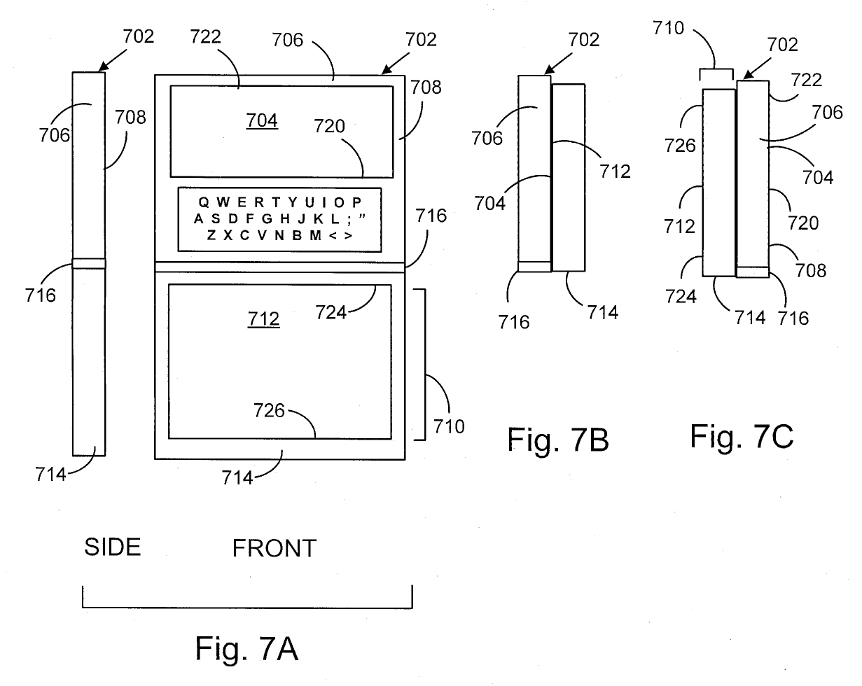

FIGS. 7A, 7B, and 7C are diagrams illustrating an input device 702 with a display 704 on a display support 706 having facing surface 708 (e.g., top or front) that faces a user when the device is held in the user's hand or hands for use. A touchpad input controller 710 includes a touchpad 712 on a touchpad base 714 that is secured by a hinged coupling 716 to display support 706. Device 702 may be a cellular telephone, for example, or any other type of portable or handheld device.

FIG. 7A shows front and side views of device 702 in a facing open position in which display 704 and touchpad 712 are facing a user when device 702 is held in the user's hand or hands during use. FIG. 7B shows device 702 in a closed position in which display 704 and touchpad 712 are facing each other and in close proximity for storage and protection of display 704 and touchpad 712. FIG. 7C shows device 702 in a folded-back open position in which display 704 is facing the user when device 702 is held in the user's hand or hands during use, and touchpad 712 is rotated coupling 716 to be not facing the user when device 702 is held in the user's hand or hands during use.

One or more fingers of one or both of the user's hands may be used on touchpad 712 to enter user input into controller 710 whenever device 702 is in the facing open position or the folded-back open position, or any intermediate position between the two open positions. Controller 708 may include one or more control buttons or keys (not shown) on display support 706 or touchpad base 714 to be accessed and operated by the user's thumbs, as described above. In the folded-back open position of FIG. 7C, device 702 and controller 710 operate in the manner described above with respect to other implementations of the present invention for keyed or free cursor motion inputs. In the facing open position of FIG. 7A, device 702 and controller 710 operate in a manner analogous to the keyed or free cursor motion inputs described above, except that the directional mapping of touchpad 712 to display 704 must be changed to accommodate the rotated relative orientations of display 704 and touchpad 712.

In the illustrated implementation, for example, hinged coupling 716 is positioned along a bottom edge 720 of display 704. Text and other information is rendered on display 704 oriented relative to the opposite top edge 722. Touchpad 712 has an edge 724 that is positioned along hinged coupling 716 and an opposite edge 726. In the facing open position of FIG. 7A, edge 724 of touchpad 712 corresponds to top edge 722 of display 704, and edge 726 of touchpad 712 corresponds to bottom edge 720 of display 704. In a free motion cursor mode, user touch motion on touchpad 712 toward edge 724 will result in display motion of a cursor toward top edge 722, and user touch motion on touchpad 712 toward edge 726 will result in display motion of a cursor toward bottom edge 720.

However, in the folded-back open position of FIG. 7C, edge 724 of touchpad 712 corresponds to bottom edge 720 of display 704, and edge 726 of touchpad 712 corresponds to top edge 722 of display 704. In a free motion cursor mode (or key input mode), user touch motion on touchpad 712 toward edge 724 will result in display motion of a cursor toward bottom edge 720, and user touch motion on touchpad 712 toward edge 726 will result in display motion of a cursor toward top edge 722.

The vertical rotation between display 704 and touchpad 712 in the change between the facing and folded-back open positions causes a vertical inversion in their orientations. As a result, controller 710 automatically inverts the mapping between touchpad 712 and display 704 when device 702 is changed between the facing and folded-back open positions. In one implementation, controller 710 maintains edges 720 and 722 as the respective bottom and top of display 704 and inverts the mapping of directional inputs from touchpad 712.

Controller 710 may detect whether device 702 is in a facing open or a folded-back open position in any of a variety of ways known in the art for detecting relation positions or alignments, including a mechanical switch that is activated differently in the two positions, an LED/photodetector or LED/reflector combination, or a magnet and hall switch combination as is commonly used to detect when a laptop computer lid is closed to turn off the display. For example, a magnet could be contained in display support 706 to move with display 704 to cause one or more output states in a hall switch contained in touchpad base 714 in the different open positions. A magnet and hall switch combination could provide a long life, simple, low cost, and reliable manner of distinguishing the facing and folded-back open positions.

As another alternative for determining the open position of device 702, touchpad base 714 may contain an accelerometer, level switch, etc. so that the local gravity direction (e.g., up vs down) of touchpad 712 can be determined, in accordance with which open position being used, and the corresponding mapping to display 704 can be applied. For example, touchpad 712 in an upward-facing direction corresponds to a facing open position, and touchpad 712 in a downward-facing direction corresponds to a folded-back open position. Other implementations may have more than two modes, according to the orientation of the touchpad or touchpads, and such an accelerometer or other orientation detector could allow the device to determine the orientation and to activate the corresponding mode. For example, one could switch between cursor mode and keyboard mode by rotating the device. Such an accelerometer-based determination could also be applied in game controller device, such as device 502 described with reference to FIG. 5

Note that this is just one example. The accelerometer may be used similarly to switch modes in devices that do not employ touchpads. Apple computer currently uses a similar approach to allow the iPhone™ to display pictures in either portrait or landscape mode, depending on with way the device is oriented in space. This aspect of the invention is new, in that the mode of the input device may be changed with orientation, not the picture display orientation. For example, in a game controller, one orientation could mean the touchpad controls player movement, whereas flipping the device over may switch the touchpad to control point of view It would be very useful in a game controller, phone, or other such handheld device.

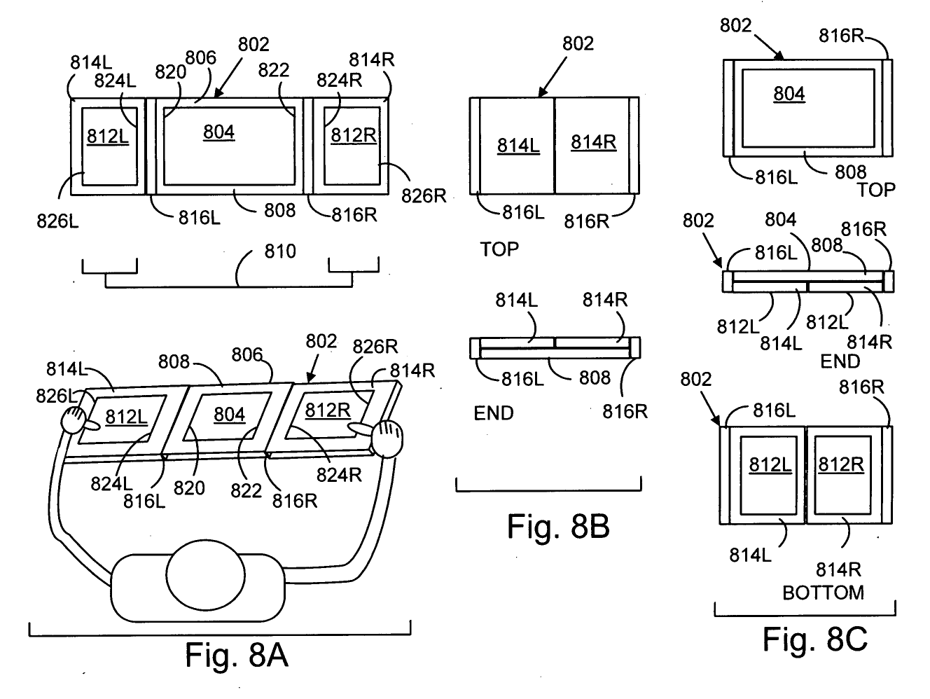

FIGS. 8A, 8B, and 8C are diagrams illustrating an input device 802 with a display 804 on a display support 806 having facing surface 808 (e.g., top or front) that faces a user when the device is held in the user's hand or hands for use. A touchpad input controller 810 includes a left touchpad 812L on a left touchpad base 814L that is secured by a hinged coupling 816L to display support 806 and a right touchpad 812R on a right touchpad base 814R that is secured by a hinged coupling 816R to display support 806. Device 802 may be a game controller or laptop computer, for example, or any other type of portable or handheld device.

FIG. 8A shows top plan and elevation views of device 802 in a facing open position in which display 804 and touchpads 812L and 812R are facing a user when device 802 is held in the user's hand or hands during use. FIG. 8B shows top plan and bottom end views of device 802 in a closed position in which display 804 and touchpads 812L and 812R are facing each other and in close proximity for storage and protection of display 804 and touchpads 812L and 812R. FIG. 8C shows top plan, bottom end and bottom plan views of device 802 in a folded-back open position in which display 804 is facing the user when device 802 is held in the user's hand or hands during use, and touchpads 812L and 812R are rotated at respective couplings 816L and 816R to be not facing the user when device 802 is held in the user's hand or hands during use.

One or more fingers of the user's left and right hands may be used on respective touchpads 812L and 812R to enter user input into controller 810 whenever device 802 is in the facing open position or the folded-back open position. Controller 808 may include one or more control buttons or keys (not shown) on display support 806 or touchpad base 814 to be accessed and operated by the user's thumbs, as described above. In the folded-back open position of FIG. 8C, device 802 and controller 810 operate in the manner described above with respect to other implementations of the present invention for keyed or free cursor motion inputs. In the facing open position of FIG. 8A, device 802 and controller 810 operate in a manner analogous to the keyed or free cursor motion inputs described above, except that the directional mapping of touchpads 812L and 812R to display 804 must be changed to accommodate the rotated relative orientations between display 804 and touchpads 812L and 812R.

In the illustrated implementation, for example, hinged couplings 816L and 816R are positioned along a left edge 820 and a right edge 822 of display 804, respectively. Text and other information is rendered on display 804 oriented relative to left edge 820 and right edge 822. Touchpad 812L has an edge 824L that is positioned along hinged coupling 816L and an opposite edge 826L, and touchpad 812R has an edge 824R that is positioned along hinged coupling 816R and an opposite edge 826R. In the facing open position of FIG. 8A, edges 826L and 826R of touchpads 812L and 812R correspond to left edge 820 and right edge 822 on display 804, respectively, and edges 824L and 824R of touchpads 812L and 812R correspond to the center of display 804.

However, in the folded-back open position of FIG. 8C, edges 824L and 824R of touchpads 812L and 812R corresponds to correspond to left edge 820 and right edge 822 on display 804, respectively, edges 826L and 826R of touchpads 812L and 812R correspond to the center of display 804.

The horizontal rotation between display 804 and touchpads 812L and 812R in the change between the facing and folded-back open positions causes a horizontal inversion in their orientations. As a result, controller 810 automatically inverts the mapping between touchpads 812L and 812R and display 804 when device 802 is changed between the facing and folded-back open positions. In one implementation, controller 810 maintains edges 820 and 822 as the respective left and right of display 804 and inverts the mapping of directional inputs from touchpads 812L and 812R. Controller 810 may detect whether device 802 is in a facing open or a folded-back open position in any of a variety of ways known in the art for detecting relation positions or alignments, as described above.

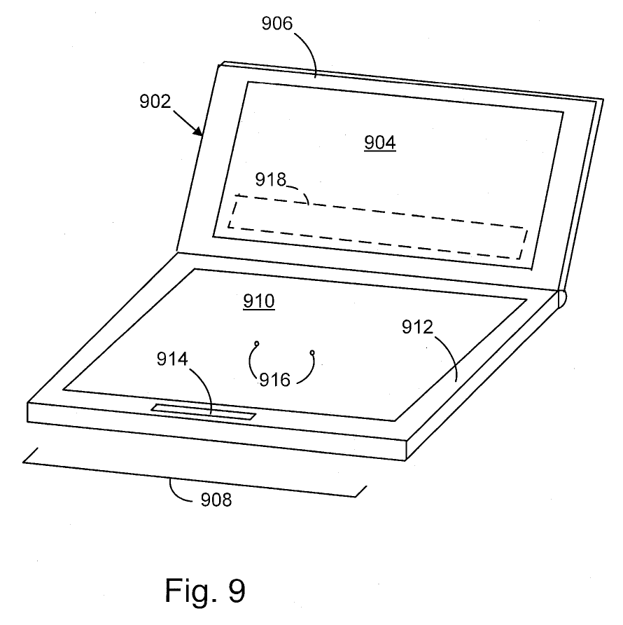

FIG. 9 is an illustration of a laptop computer 902, as an implementation of an electronic device, with a display 904 on a facing surface 906 (e.g., top or front) that faces a user when the device is in use. A touchpad input controller 908 includes a touchpad 910 also on a facing surface 912 that faces the user when device 902 is in use. One or more fingers of both the hands are used on touchpad 910 to enter user input into controller 908. Controller 908 may include an optional control button or key 914 that is positioned on facing surface 912 to be accessed and operated by the user's thumbs as, for example, keyboard control keys (e.g. space). The user may assign any such functionality to key 914 or may use a predefined default functionality.

Controller 908 illustrates operation in a keyboard-equivalent input mode for text entry. Display 904 includes a keyboard display area 918 that displays the letters of a virtual keyboard (not shown). Keyboard display area 918 may show a standard QWERTY-style arrangement. It will be appreciated, however, that any keyboard arrangement could be displayed in keyboard display area 918. In addition, the virtual keyboard could alternatively include any number of virtual control keys that have assigned control key functions that are the same as, or different from those assigned to control key 914. Note that controller 908 could also employ a free cursor moved that could replace a mouse for graphical user interface navigation, icon selection, and so forth.

Touchpad 910 on facing surface 912 allows the user to make key selections using one or more fingers on one or both hands. Locations on touchpad 910 may be mapped directly to a keyboard layout that corresponds to the virtual keyboard, alternatively, the motion of the fingers in contact with touchpad 910 may change the key selections through relative movements, finger sweeps, and gestures, as with a mouse or touchscreen. As the user moves his hands or fingers over touchpad 910, visual feedback is provided on virtual keyboard 920 that is displayed in keyboard display area 918 to indicate which letter is currently selected, as described above. It will be appreciated, therefore, that controller 908 and touchpad 910 provide a solid-state alternative to the conventional mechanical keyboard of a laptop computer, or any other computer.

The solid state nature of touchpad 910 could lower the cost of laptop computers, simplify construction by eliminating a mechanical keyboard and separate mouse device, and increase reliability. It may also allow such laptops to be made much thinner than they currently are, which is highly desired by consumers. One could also make a computer for “harsh” environments that would use the invention to more adequately seal the case from moisture and grit.

It will be appreciated that touchpad 910 may be a flexible mat, not rigid. It may be a completely separate device or accessory that communicates with the primary computer using wireless means such as RF or IR. This would be similar to a wireless keyboard, as is currently available. Also, touchpad 910 could be positioned opposite display 904 on a non-facing surface in the manner described herein for other embodiments of the invention.

Touchpad 910, or any other touchpad described herein, may include structural variations such as physical bumps, detents, texture changes, or other features, to help a user locate his hand or fingers in a consistent manner for text or keyed entry. Touchpad 910 may have two dimples (or nipples) 916 to indicate locations for selected keys (e.g., the letters F and J), or may have a texture change (e.g., increased roughness) or may have the letters of the selected keys embossed or extruded slightly. Similarly, every key on the keyboard, or some subset, may be identified with similar physical feature to facilitate faster keyed or text entry or typing.

In any of the implementations of the invention, the display may also be touch sensitive to provide input more modes and flexibility. As described throughout, the touchpad may correspond to a full keyboard. A joystick or thumb controller may also be added to provide free motion cursor operation.

Additionally, in any of the implementations of the invention, the front facing display may be clear semi-transparent, or translucent through to the touchpad or touchpads on the backside surface of the device, and the touchpad or touchpads can also be clear, semi-transparent, or translucent, thereby allowing the user to “see-through” the device. As a result, a user could see his fingertips through the device as they move on the surface on the reverse side of the display. The user can then select graphical objects on the forward facing display with his fingertip on the reverse side while seeing the object and his finger simultaneously.

The front facing side of this display could also include a touchpad in addition to the touchpad or touchpads on the reverse side to provide additional usage flexibility, including the ability to grab a graphical object from either side of the device.

It should also be clear that the invention may be used to control the secondary displays on devices such as cell phone or laptops that incorporate auxiliary displays on their lids that are visible when the clamshell is closed. Such displays are common on cell phones to display recent calls or other such data when the device is closed.

It will be appreciated that touchpads are known in the art and may be constructed in a variety of ways, employing surface capacitive pads, projected capacitive pads, resistive pads, optical sensing utilizing frustrated internal reflection, surface acoustic wave sensing, conductive fabric, infrared sensing, liquid crystal display, optical imaging, display panels capable of image sensing, assorted hybrid combinations of these technologies, or even linear controls such as potentiometers (one-dimensional touchpads) and may further include touch force determination to provide additional input information. Also, the touchpad may be incorporated as part of a non-forward facing display, such as a backside “touchpad” also functioning as a secondary display with touch sensitivity and functionality. Likewise, the present invention includes a device with one or more displays and one or more touchpads that can be in facing or non-facing positions. The input modes are compatible with keyed entry (text or numeric or other dedicated controls) as well as free motion cursor control, as is used in web browsing and in various graphical user interfaces.

Having described and illustrated the principles of my invention with reference to an illustrated embodiment, it will be recognized that the illustrated embodiment can be modified in arrangement and detail without departing from such principles. In view of the many possible embodiments to which the principles of our invention may be applied, it should be recognized that the detailed embodiments are illustrative only and should not be taken as limiting the scope of our invention. Rather, I claim as my invention all such embodiments as may come within the scope and spirit of the following claims and equivalents thereto.

1. A touchpad input controller for receiving user input relating to a display, comprising:
a facing surface that faces a user when the controller is held in the user's hand or hands during use;
one or more non-facing surfaces that each faces away from the user when the controller is held in the user's hand or hands during use, at least one non-facing surface including a touchpad input area that is positioned to be accessed by at least one user finger for receiving user input.

2. The input controller of claim 1 in which the touchpad input area is included on a non-facing surface that is opposite the facing surface.

3. The input controller of claim 2 in which the touchpad input area includes a mapping to a virtual keyboard layout for receiving keyboard-equivalent input from the user at the touchpad input area.

4. The input controller of claim 3 further including a free motion mapping in which the touchpad input area is mapped to free cursor motion across the display.

5. The input controller of claim 1 further including a free motion mapping in which the touchpad input area is mapped to free cursor motion across the display.

6. The input controller of claim 1 in which the touchpad input area includes right- and left-side segments that are accessible and active for receiving user input simultaneously by at least one finger of each of the user's right and left hands, respectively.

7. The input controller of claim 6 in which the touchpad input area includes a mapping to a virtual keyboard layout for receiving keyboard-equivalent input from the user at the touchpad input area, whereby the right- and left-side segments are mapped to keys that are accessible user input simultaneously by at least one finger of each of the user's right and left hands, respectively.

8. The input controller of claim 1 in which the right- and left-side segments are portions of a single touchpad input area.

9. The input controller of claim 1 in which the right- and left-side segments are separate touchpad input areas.

10. The input controller of claim 1 in which the facing surface includes a display on which the results of user input received at the touchpad input area is displayed.

11. The input controller of claim 1 in which the display is not included in the input controller.

12. The input controller of claim 1 further comprising one or more control keys other than the touchpad input area positioned to be accessed by at least one user finger for receiving user input.

13. A touchpad input controller for receiving user input relating to a display, comprising:
a touchpad input area that is positioned to be accessed by at least one user finger for receiving user input, the touchpad input area including a mapping to a virtual keyboard layout for receiving keyboard-equivalent input from the user at the touchpad input area; and
a display rendering of the virtual keyboard layout indicating each keyboard-equivalent input from the user at the touchpad input area.

14. The input controller of claim 13 further including a free motion cursor mapping in which the touchpad input area is mapped to a free motion cursor display rendering.

15. The input controller of claim 14 further including a user-operable control for switching between the mapping to the virtual keyboard layout and the free motion cursor mapping.

16. The input controller of claim 15 further including a physical key or button that functions as the user-operable control for switching between the mapping to the virtual keyboard layout and the free motion cursor mapping.

17. The input controller of claim 15 further including a display rendering of a virtual key or button that functions as the user-operable control for switching between the mapping to the virtual keyboard layout and the free motion cursor mapping.

18. The input controller of claim 15 further including a mapping of a first region of the touchpad input area to the virtual keyboard layout and a second region of the touchpad input area to the free motion cursor mapping.

19. The input controller of claim 13 in which the touchpad area is pivotable between a facing orientation that faces the user when the controller is in use and a non-facing orientation that faces away from the user when the controller is in use, the controller inverting the mapping to the virtual keyboard layout from the touchpad input area when the touchpad input area is pivoted between the facing and non-facing orientations.

20. The input controller of claim 13 in which the touchpad area is pivotable in a vertical direction between the facing and non-facing orientations and the controller vertically inverts the mapping to the virtual keyboard layout from the touchpad input area.

21. The input controller of claim 13 in which the touchpad area is pivotable in a horizontal direction between the facing and non-facing orientations and the controller horizontally inverts the mapping to the virtual keyboard layout from the touchpad input area.

22. The input controller of claim 13 in which user input of a keyboard selection is entered by the user at the touchpad input area.

23. The input controller of claim 13 further including a physical key or button and in which in which user input of a keyboard selection is entered by user activation of the physical key or button.

24. The input controller of claim 13 in which the touchpad input area is included in a laptop computer.

25. The input controller of claim 13 further including a free motion cursor mapping in which the touchpad input area is mapped to a free motion cursor display rendering of a video game, wherein the input controller operates as a game controller for the video game.

26. A touchpad input controller for receiving user input relating to a display, comprising:
a touchpad input area that is positioned to be accessed by at least one user finger for receiving user input, the touchpad input area including first and second mappings to a virtual keyboard layout for receiving keyboard-equivalent input from the user at the touchpad input area when the touchpad is in first and second orientations, respectively; and
a display rendering of the virtual keyboard layout indicating each keyboard-equivalent input from the user at the touchpad input area.

27. The input controller of claim 26 in which the touchpad area is pivotable between a facing orientation that faces the user when the controller is in use and a non-facing orientation that faces away from the user when the controller is in use, the controller inverting the mapping to the virtual keyboard layout from the touchpad input area when the touchpad input area is pivoted between the facing and non-facing orientations.

28. The input controller of claim 26 further comprising a detector for detecting when the touchpad is in the first and second orientations.

29. The input controller of claim 28 in which the detector includes an accelerometer.
